(19) United States
(12) Patent Application Publication
(10) Pub. No.: US 2023/0302497 A1
(43) Pub. Date: Sep. 28, 2023

(54) FORCE FIELD-GENERATING DEVICE, FORCE FIELD-GENERATING METHOD, AND NON-TRANSITORY STORAGE MEDIUM

(71) Applicant: Toshihiko HOSOYA, Tokyo (JP)

(72) Inventor: Toshihiko HOSOYA, Tokyo (JP)

(21) Appl. No.: 18/116,890

(22) Filed: Mar. 3, 2023

(30) Foreign Application Priority Data
Mar. 23, 2022 (JP) 2022-046548

(51) Int. Cl. B06B 3/04

(52) U.S. Cl. CPC B06B 3/04

(57) ABSTRACT

A force field-generating device, including: an output unit including a plurality of wave sources that are disposed at different positions and generate ultrasonic waves; and a control device configured to individually control the plurality of wave sources, individually adjust parameters of a direction, a frequency, an amplitude, and a phase of each of the ultrasonic waves, generate the plurality of ultrasonic waves having different frequencies from the plurality of wave sources, combine the plurality of ultrasonic waves at a target position inside a target object, and generate a force having a desired direction, a desired intensity, and a desired shape.

### BACKGROUND OF THE INVENTION

### Field of the Invention

The present invention relates to a force field-generating device, a force field-generating method, and a non-transitory storage medium.

Priority is claimed on Japanese Patent Application No. 2022-046548, filed Mar. 23, 2022, the content of which is incorporated herein by reference.

### DESCRIPTION OF RELATED ART

Methods for generating a spatial pattern of a force having a high degree of freedom in a nondestructive manner for an arbitrary position inside a space or inside an object have been researched. For example, in a case in which a force is generated using a static electric field or a static magnetic field, it is necessary to determine whether a target is charged and whether a target has a magnetic force, and thus an applicable situation is limited. In a case in which a force is generated using electromagnetic waves, the electromagnetic waves sharply attenuate in many media including a living body, and thus it is difficult to generate a force. On the other hand, ultrasonic waves propagate relatively well in various materials, and technologies for generating a force by forming a radiation pressure or standing waves are already known.

For example, in Patent Document 1, a technology for generating an acoustic field causing a human body to have a tactile feeling at a predetermined position inside a space on the basis of ultrasonic waves generated from a plurality of sound sources is disclosed. In addition, in Non-Patent Document 1, a technology for generating a desired acoustic field inside a space on the basis of ultrasonic waves generated from a plurality of sound sources is disclosed. According to the technologies disclosed in Patent Document 1 and Non-Patent Document 1, there are problems in that the frequency of each sound source is limited to the same specific values, and there are restrictions on a direction and a shape of a force based on a generated acoustic field.

### SUMMARY OF THE INVENTION

An object of the present invention is to provide a force field-generating device, a force field-generating method, and a non-transitory storage medium capable of applying a desired force having an arbitrary direction and an arbitrary intensity to an arbitrary area inside an object.

According to one aspect of the present invention, a force field-generating device is provided, including: an output unit including a plurality of wave sources that are disposed at different positions and generate ultrasonic waves; and a control device configured to individually control the plurality of wave sources, individually adjust parameters of a direction, a frequency, an amplitude, and a phase of each of the ultrasonic waves, generate a plurality of ultrasonic waves having different frequencies from the plurality of wave sources, combine the plurality of ultrasonic waves at a target position inside a target object, and generate a force having a desired direction, a desired intensity, and a desired shape.

According to the present invention, a desired force can be applied to an arbitrary area inside an object.

### BRIEF DESCRIPTION OF THE DRAWINGS

FIG. 1 is a block diagram illustrating a configuration of a force field-generating device according to an embodiment of the present invention.

FIG. 2 is a plan view illustrating a configuration of an output unit.

FIG. 3 is a diagram illustrating a method of controlling a direction of ultrasonic waves output from a wave source.

FIG. 4 is a diagram illustrating a state in which ultrasonic beams are output from a plurality of wave sources to a target position.

FIG. 5 is a diagram illustrating a state in which spherical waves are output from a plurality of wave sources to a target position.

FIG. 6 is a diagram illustrating a principle of generation of a force based on two waves advancing in opposing directions.

FIG. 7 is a diagram illustrating a principle of generation of a force based on two waves advancing in different directions.

FIG. 8 is a diagram illustrating a principle of generation of a force based on three waves advancing in different directions.

FIG. 9 is a diagram illustrating a principle of generation of a force based on a plurality of waves of different frequencies advancing in different directions.

FIG. 10 is a diagram illustrating a principle of generation of forces of different patterns based on a plurality of waves of different frequencies advancing in different directions.

FIG. 11 is a diagram illustrating results of simulations for generating forces on the basis of a plurality of ultrasonic waves.

FIG. 12 is a diagram illustrating results of simulations for generating forces of different patterns on the basis of a plurality of ultrasonic waves.

FIG. 13 is a flowchart illustrating a process of a force field-generating method.

### DETAILED DESCRIPTION OF THE INVENTION

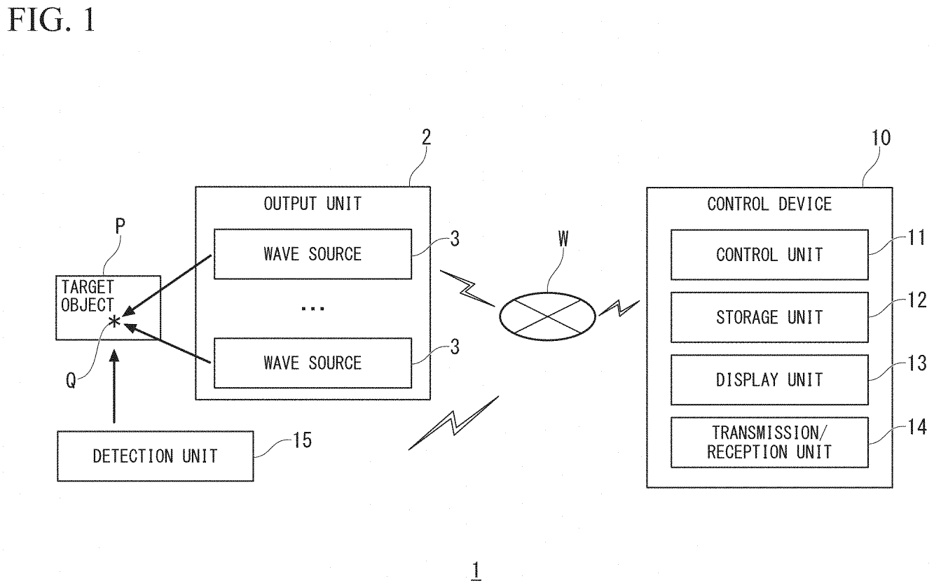

As illustrated in FIG. 1, a force field-generating device 1 includes an output unit 2 that outputs ultrasonic waves to a target object P, a control device 10 that controls the output unit 2, and a detection unit 15 that detects a target position R of the target object P. For example, the output unit 2 includes a plurality of wave sources 3 that generate ultrasonic waves. The wave sources 3 are disposed at different positions. The configuration of the wave source 3 will be described below.

The control device 10, for example, includes a control unit 11 that controls the output unit 2 on the basis of a detection value acquired by the detection unit 15, a storage unit 12 in which data required for control is stored, a display unit 13 that display information for performing control, and a transmission/reception unit 14 that transmits/receives signals to/from the detection unit 15 and the output unit 2.

The control device 10 may be connected to the output unit 2 and the detection unit 15 via a network W. For example, the network W is configured using a public communication line, a LAN, a WAN, or the like. The network W may be configured using various kinds of communication lines of wired communication, wireless communication, or the like. The network W may be configured to perform near-field communication.

For example, the control device 10 acquires a detection value from the detection unit 15. For example, the control unit 10 is configured using an information-processing device such as a personal computer, a tablet terminal, or a smartphone. The control device 10 may be a server apparatus connected to the network W. The control device 10 may be configured to operate in association with the output unit 2 and the detection unit 15 on the network W and may be integrally configured with the output unit 2 and the detection unit 15.

The detection unit 15 detects a target position R inside a target object P generating a force field. For example, in a case in which a target object P is a human body, the detection unit 15 may be a magnetic resonance imaging (MRI) device. As the detection unit 15, any device may be used as long as it can measure a target position R inside a target object P.

The control device 10, for example, acquires measurement data from the detection unit 15 through the transmission/reception unit 14. The transmission/reception unit 14, for example, is a communication interface that can transmit and receive data. The transmission/reception unit 14 stores acquired data in the storage unit 12. The transmission/reception unit 14, as described below, outputs a control signal of the control unit 11 to the output unit 2. The storage unit 12, for example, is a non-transitory storage device configured using a hard disk drive (HDD), a flash memory, or the like. The storage unit 12 may be provided integrally with or separately from the control device 10 and may be a server apparatus connected to a network W.

The measurement data stored in the storage unit 12 is read by the control unit 11. The control unit 11, for example, calculates a relative position relationship between each wave source 3 and the target position R on the basis of the measurement data. For example, on the basis of the measurement data, the control unit 11 calculates coordinates of each wave source 3 with reference to a position of an origin set in advance and calculates coordinates of a target position R.

The control unit 11 individually controls the plurality of wave sources 3.

The control unit 11, for example, individually adjusts parameters of a direction, a frequency, an amplitude, and a phase of each of ultrasonic waves output from the plurality of wave sources 3 and generates a plurality of ultrasonic waves having different frequencies from the plurality of wave sources. The control unit 11, for example, combines the plurality of ultrasonic waves at a target position R inside an object and generates a force having a desired direction, a desired intensity, and a desired shape. The control unit 11, for example, generates an image representing a state of the generated ultrasonic waves and causes the display unit 13 to display the image.

The display unit 13, for example, is a display device configured using a liquid crystal display, an organic EL display, or the like. For example, the display unit 13 may be an operation unit that is configured using a touch panel and inputs operation information used for operating the control device 10. The operation unit may be disposed in a separate body.

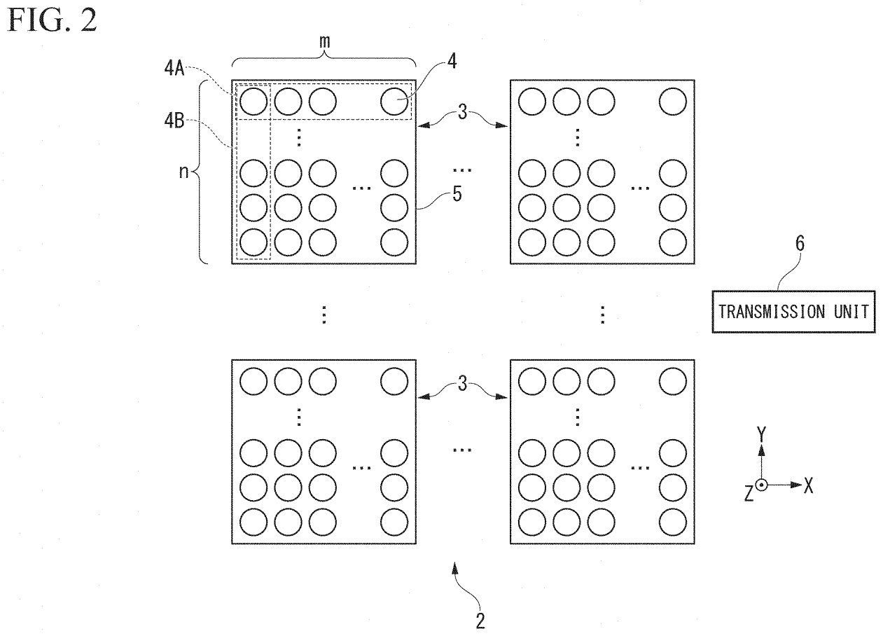

As illustrated in FIG. 2, the output unit 2 is composed of the plurality of wave sources 3 disposed at different positions and a transmission unit 6 controlling the wave sources 3. Each wave source 3 is formed to be able to input an ultrasonic wave to the inside of a target object P. For example, in a case in which the target object P is a human body, each wave source 3 may be formed on a pad such that it can be attached to a target object P. The wave sources 3 may be aligned on one substrate 5. Each wave source 3 is electrically connected to the transmission unit 6.

Each wave source 3 is an ultrasonic transducer of a phased array type composed of a plurality of ultrasonic vibrators 4. Each wave source 3, for example, includes the plurality of ultrasonic vibrators 4 disposed in a matrix pattern. For example, the plurality of ultrasonic vibrators 4 are arranged in a matrix pattern of m x n (here, m and n are arbitrary natural numbers) on the substrate 5. On the substrate 5, an ultrasonic vibrator unit 4A corresponding to one column of m ultrasonic vibrators 4 is formed in a first direction (an X axis direction in the drawing). An ultrasonic vibrator unit 4B corresponding to one column of n ultrasonic vibrators 4 is formed in a second direction (an Y axis direction in the drawing) that is a direction orthogonal to an arrangement direction of the ultrasonic vibrator unit 4A.

The method of arrangement of the plurality of ultrasonic vibrators 4 is an example, and any other arrangement method may be used. In addition, in each wave source 3, values of m and n may be different from each other. By adjusting the number of the plurality of ultrasonic vibrators 4 to be controlled in each wave source 3, the values of m and n may be adjusted. In a case in which the plurality of ultrasonic vibrators 4 arranged in a matrix pattern are disposed on one substrate 5, by dividing the substrate 5 into a plurality of areas having an arbitrary size and individually controlling each area, a plurality of wave sources 3 may be configured.

Each ultrasonic vibrator 4 is electrically connected to a transmission circuit (not illustrated) individually disposed in the transmission unit 6. Each ultrasonic vibrator 4 includes a vibrator vibrating on the basis of high-frequency power output from a transmission circuit and outputs an ultrasonic vibration on the basis of a vibration of the vibrator. Each transmission circuit is individually controlled by the control unit 11. The control unit 11 individually controls each transmission circuit and individually adjusts parameters of a frequency, an amplitude, and a phase of an ultrasonic wave output from each ultrasonic vibrator 4.

For example, the control unit 11 generates an ultrasonic beam advancing in a beam shape of which frequencies and amplitudes of the plurality of ultrasonic vibrators 4 configuring each wave source 3 are the same, individually adjusts the phase of each ultrasonic vibrator 4, and adjusts an advancement direction of the ultrasonic beam. The ultrasonic beam advances while forming a planar wave of a compression wave.

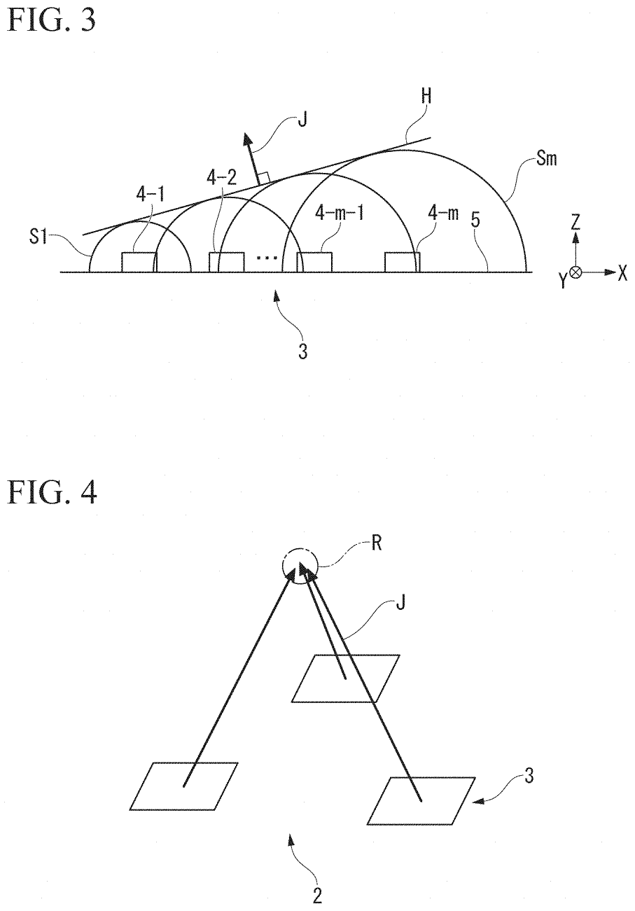

As illustrated in FIG. 3, an ultrasonic wave of a spherical wave Sm is output from each ultrasonic vibrator 4-m of the ultrasonic vibrator unit 4A. At this time, when phases of ultrasonic waves output from ultrasonic vibrators 4-m adjacent to each other are delayed by a predetermined amount in a first direction, a planar wave J in which an envelope H of a spherical wave Sm of an ultrasonic wave output from each ultrasonic vibrator 4-m is an equi-phase surface is formed. This planar wave J advances in a direction orthogonal to the envelope H.

Similarly, by delaying phases of ultrasonic waves output from ultrasonic vibrators 4-n (not illustrated) adjacent to each other in the ultrasonic vibrator unit 4B (see FIG. 2) in a direction orthogonal to the ultrasonic vibrator unit 4A by a predetermined amount in a second direction, the advancement direction of the formed planar wave J can be adjusted. On the basis of the control method described above, an ultrasonic beam of a planar wave advancing in an arbitrary direction of directions in three dimensions from the wave source 3 can be formed.

The wave source 3 may be configured to cause an ultrasonic wave to advance in a specific direction using an acoustic prism other than being configured in a phased array in which the plurality of ultrasonic vibrators 4 are arranged.

As illustrated in FIG. 4, the control unit 11 can output a plurality of planar waves J to a target position R by individually adjusting parameters of frequencies, amplitudes, and phases of ultrasonic waves output from the plurality of ultrasonic vibrators 4 disposed in the plurality of wave sources 3. In accordance with this, the control unit 11 can generate a force having a desired direction, a desired intensity, and a desired shape by generating a plurality of ultrasonic waves having different frequencies from the plurality of wave sources 3 and combining a plurality of ultrasonic waves at a target position R inside an object.

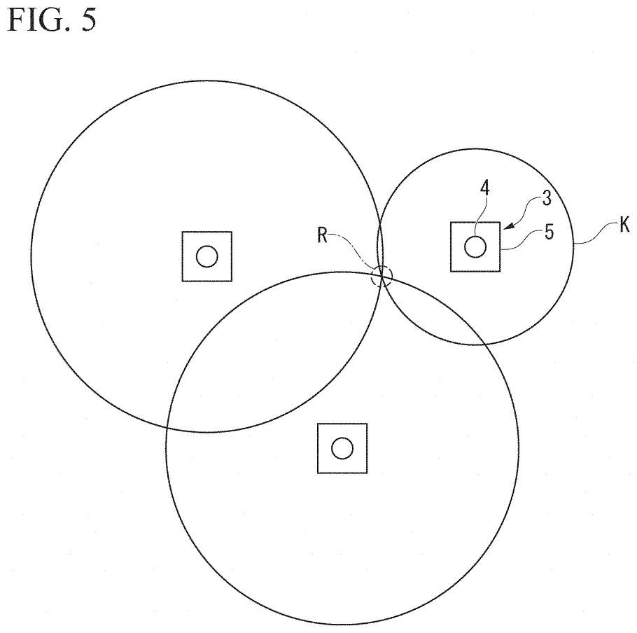

As illustrated in FIG. 5, in a case in which one ultrasonic vibrator 4 is disposed in each wave source 3 (m, n=1), a spherical wave K of an ultrasonic wave is output from each wave source 3. The control unit 11 may generate a force having a desired direction, a desired intensity, and a desired shape by generating spherical waves K of a plurality of ultrasonic waves having different frequencies from the plurality of wave sources 3 and combining the plurality of ultrasonic waves at the target position R. At the target position R, a part of each spherical wave K can be approximated as a planar wave, and thus, similar to combination of planar waves, a force having a desired direction, a desired intensity, and a desired shape can be generated.

Hereinafter, a principle of generation of a desired force at the target position R will be described.

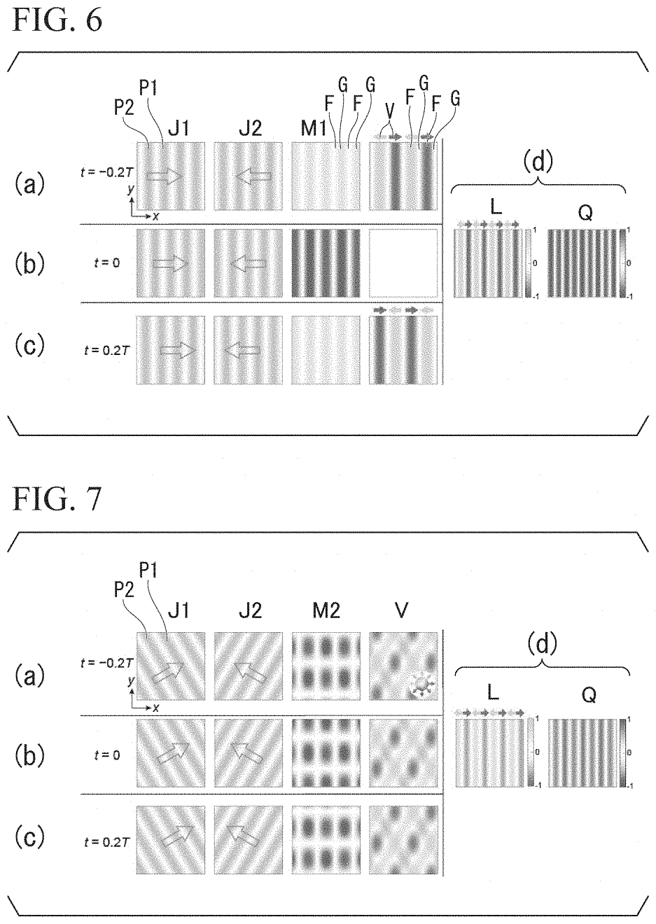

FIG. 6 illustrates a principle of generating a force on the basis of a standing wave generated by combining ultrasonic waves. Corresponding areas illustrated in FIGS. 6(a), 6(b), and 6(c) are predetermined areas that are the same in a space. In the drawing, x and y represent two axes in the space. FIGS. 6(a), 6(b), and 6(c) represent a state occurring in a predetermined area at different times t. Here, T is one period of a sound wave. As illustrated in FIG. 6(a), in a case in which two planar waves J1 and J2 adjusted to the same frequency and the same amplitude advancing in opposite directions in a medium are combined, a standing wave (a combined wave M1) is generated. In the medium, as a pressure (dense/coarse) of a propagating wave, a positive pressure P1 (dense) and a negative pressure P2 (coarse) are generated. In the drawing, intensities of the positive pressure P1 and the negative pressure P2 are represented using densities.

In a standing wave, a part (an antinode G) at which a pressure greatly varies in accordance with a position and a part (a node F) at which a pressure hardly varies are generated. Near the antinode G, variations of the pressure over time increase, and pressures applied to a medium from respective directions are balanced, and thus variations of a speed V of a wave propagating through the medium are small (see the right side in FIGS. 6(a), 6(b), and 6(c)). On the other hand, at the position of the node F, a spatial gradient of the pressure increases, and a large force is applied to the medium, and thus variations of the speed V of a wave propagating through the medium become large (see the right side in FIGS. 6(a), 6(b), and 6(c)).

As described above, while a medium located at the position of an antinode G hardly moves in accordance with a balance of the pressure (V=0), a medium located at the position of a node F receives a force generated in accordance with a spatial gradient and vibrates (−V˜+V). A frequency of this vibration is the same frequency as that of a sound wave. As described above, in a case in which a standing wave is generated in a medium, a part that hardly vibrates and a part that strongly vibrates are adjacently generated. As a result, in the medium, a force pressing the medium in a direction from a part that strongly vibrates to a part having no vibration (a tensile force L) is generated in accordance with transfer of a momentum (see the left side in FIG. 6(d)). This force is stationary over time and is represented to be a potential force Q based on elastic transformation of the medium (see the right side in FIG. 6(d)).

As described above, when a standing wave M1 is generated in accordance with superposition of two sound waves, a force having a spatial periodical pattern is generated in a medium. In a case in which the medium is in a gel state in which a macro flow is not generated, the force described above given from the sound waves is balanced with a force generated in the surrounding medium and generates a tensile force L (see the left side in FIG. 6(d)).

As illustrated in FIG. 7, also in a case in which two planar waves J1 and J2 do not advance oppositely, a spatial pattern of a periodical force is generated in the medium. In the spatial pattern, elements of parameters of a direction, an intensity, a frequency, and a shape of a force are included. In this case, a combined wave M2 does not become a standing wave but a traveling wave (see FIGS. 7(a), 7(b), and 7(c)). Compared with a case in which two planar waves J1 and J2 advance oppositely (see FIG. 6), a magnitude of the force and an amplitude of the potential become small, and a periodical wavelength becomes long (see FIG. 7(d)). In the medium, a potential force that is stationary over time and is spatially periodical is generated.

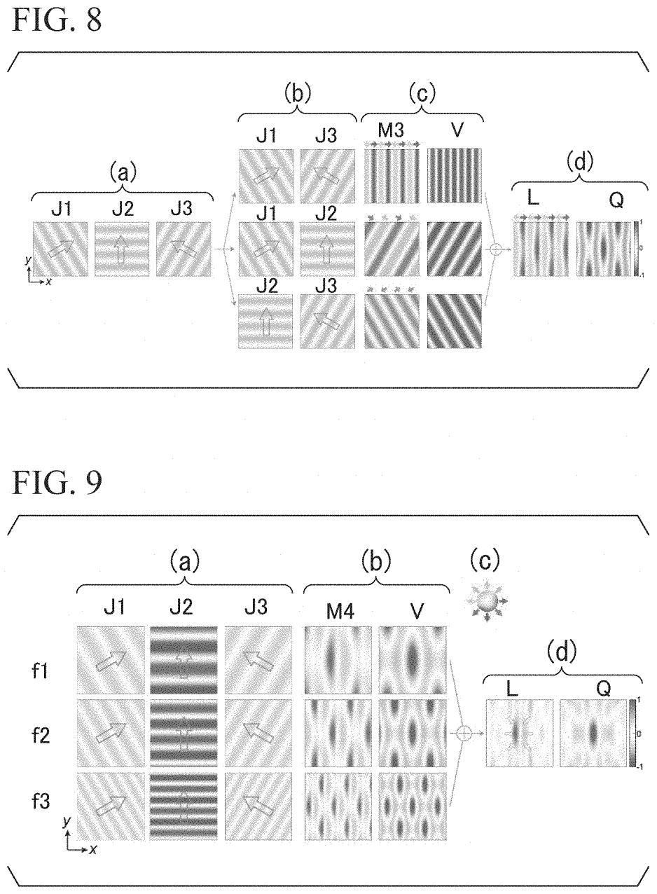

As illustrated in FIG. 8, also in a case in which there are three or more planar waves J1, J2, and J3 of the same frequency, a periodical force based on a combined wave M3 of the planar waves J1, J2, and J3 is generated in the medium. When the number of waves is N (here, N≥2), a force having a periodical pattern as described above is generated for each of all the combinations (_{N}C₂) of two waves among N waves (see FIGS. 8(a), 8(b), and 8(c)), and a spatial pattern of a force is generated on the basis of a sum thereof (see FIG. 8(d)).

As illustrated in FIG. 9, in a case in which three planar waves J1, J2, and J3 are combined on the basis of a condition of different frequencies (f1<f2<f3), a combined wave M4 of the planar waves J1, J2, and J3 at a low frequency (f1) forms a force of a spatial pattern having a long wavelength (see an upper stage in FIG. 9(b)). A combined wave M4 of planar waves J1, J2, and J3 at a high frequency (f3) forms a force of a spatial pattern having a short wavelength (see a lower stage in FIG. 9(b)). By performing superposition of combined waves M4 of different frequencies, a pattern of the force is generated (see FIG. 9(d)). The direction of the force is represented in FIG. 9(c).

The combined wave M4 of different frequencies generates different spatially-repeated potential forces (see FIG. 9(b)), and a potential force that is the same as a sum of the potential forces is generated (see FIG. 9(d)). These have different spatial frequencies, and thus a sum thereof can be spatially localized (see FIG. 9(d)). In the example illustrated in FIG. 9, a localized pressure force is generated in the medium.

As illustrated in FIG. 10, four planar waves J1, J2, J3, and J4 may be combined on the basis of a condition of different frequencies (f1<f2<f3). A combined wave M5 acquired by combining four planar waves J1, J2, J3, and J4 on the basis of a condition of different frequencies forms a spatial pattern of a force having various wavelengths that are spatially localized (see FIG. 10(b)). Each of the combined waves M5 acquired by combining the four planar waves J1, J2, J3, and J4 forms a potential force that is spatially repeated (see FIG. 10(b); a direction of the force is illustrated in FIG. 10(c)). When three combined waves M5 of different frequencies are combined, a potential force that is the same as a sum thereof is generated (see FIG. 10(d)).

As illustrated in FIG. 10(d), when the three combined waves M5 of different frequencies are combined, in contrast to FIG. 9(d), a force in a direction for expanding from a center (a target position R) inside the area is locally generated. As described above, in a case in which a plurality of combined waves M5 of different frequencies are combined, localized forces that are localized to have various patterns can be realized on the basis of waves of many directions having a plurality of frequencies included in the combined waves M5 (see FIG. 10(d)).

As described above, a force pattern generated in the medium can be computed on the basis of adjustable parameters of the number, the direction, the frequency, the amplitude, and the phase of given ultrasonic waves. Thus, according to the force field-generating device 1, the control unit 11 can output ultrasonic beams of different frequencies that are optimized from the plurality of wave sources 3 and generate a desired pattern of a force at the target position R in the medium (see FIG. 4). Here, differences in sizes of diameters of ultrasonic beams have no influence on forces considered here.

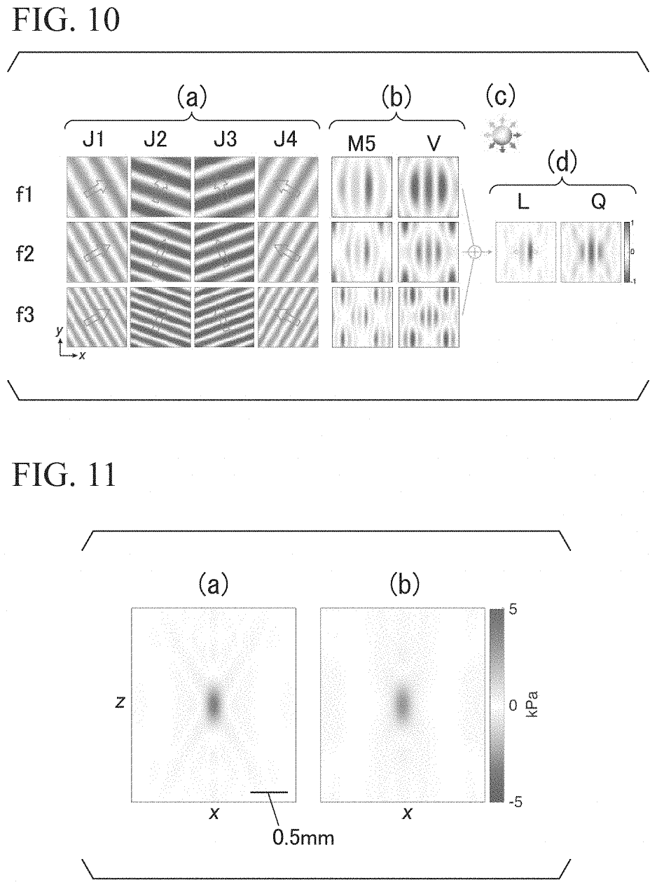

FIG. 11 illustrates the results of simulations for generating a force at a target position R inside a living body. In the drawings, in each result, a force is generated in an area having a diameter of about 100 um. As a condition for the simulations, a sound speed propagating through the living body and a density of the living body are set to be the same as those of water. The sound wave advances from bottom to top, and an angle between the direction thereof and a z axis (a vertical direction) is set to be equal to or lower than 60°. The sound wave is set to 6 kinds of frequencies that are equal to or lower than 6 MHz. As illustrated in the drawing, a potential generated in accordance with a sound wave is illustrated using shading. A size bar in the illustrated area is 0.5 mm.

As illustrated in FIG. 11(a), a negative potential localized in a predetermined area is generated, and a force pressing a center part of a predetermined area is generated. Sound waves are input by the plurality of wave sources 3 in 81 directions, and an amplitude of each frequency component is equal to or smaller than 0.5 atmospheres. As illustrated in FIG. 11(b), a positive potential localized in a predetermined area is generated, and a force expanding from a center of the predetermined area to an outer side is locally generated. Sound waves are input by the plurality of wave sources 3 in 96 directions, and an amplitude of each frequency component is equal to or smaller than 2.5 atmospheres.

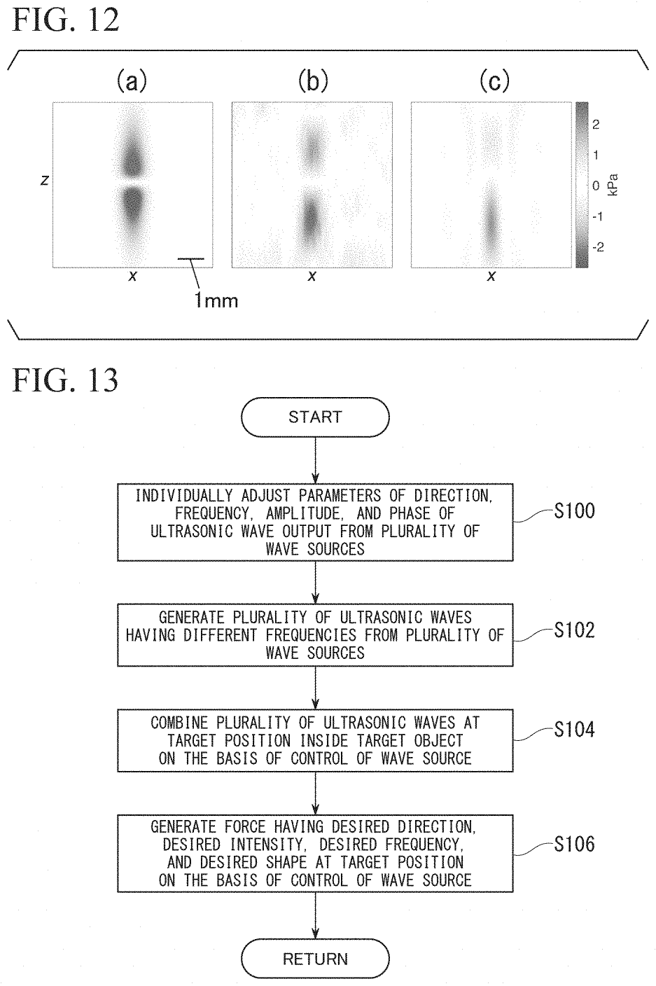

FIG. 12 illustrates a result of comparison between a force generated on the basis of sound waves of a plurality of frequencies and a force generated on the basis of a sound wave of a single frequency. As conditions for a simulation, a sound speed for propagation in the living body and a density are set to be the same as those of water. A sound wave advances from bottom to top, and an angle formed by the direction thereof and the z axis (the vertical direction) is set to be equal to or smaller than 60°. Sound waves are input by the plurality of wave sources 3 in 144 directions, and a frequency is set to be equal to or lower than 7 MHz. A size bar in the illustrated area is 1 mm.

The amplitude of each frequency is set to 10 atmospheres or less in the case of 6 frequencies and is set to 60.5×10 atmospheres or less in the case of one frequency. A sound wave of a plurality of frequencies and a sound wave of a single frequency are set such that they have equal powers as a whole. In any of a case in which a force is generated on the basis of sound waves of a plurality of frequencies and a case in which a force is generated on the basis of a sound wave of a single frequency, an optimization condition is set such that the entire power of the sound wave has a similar value.

FIG. 12(a) illustrates a spatial pattern of a target force. FIG. 12(b) illustrates a spatial pattern of a force optimized on the basis of a plurality of sound waves of 6 frequencies such that a potential that is as close to that illustrated in FIG. 12(a) as possible is generated. FIG. 12(c) illustrates a spatial pattern of a force optimized on the basis of a plurality of sound waves of one frequency such that a potential as close to that illustrated in FIG. 12(a) as possible is generated.

A spatial pattern of a force generated on the basis of a plurality of sound waves of six frequencies is optimized such that it becomes close to a spatial pattern of a target force. Compared to the spatial pattern of the force generated on the basis of the plurality of sound waves of six frequencies, the spatial pattern of the force generated on the basis of the plurality of sound waves of one frequency has low reproducibility of a spatial pattern of a target force. In a case in which a complicated force is generated in accordance with the simulation result described above, it is illustrated that a case of using ultrasonic waves of a plurality of frequencies is advantageous over a case of using sound waves of a single frequency.

By using the force field-generating device 1 described above, a force field-generating method can be realized. In FIG. 13, the flow of a process of the force field-generating method is illustrated using a flowchart. The control device 10 individually adjusts parameters of directions, frequencies, amplitudes, and phases of ultrasonic waves output from the plurality of wave sources 3 of the output unit 2 including a plurality of wave sources disposed at different positions (Step S100). The control device 10 generates a plurality of ultrasonic waves having different frequencies from the plurality of wave sources 3 (Step S102). The control device 10 combines the plurality of ultrasonic waves at a target position inside a target object on the basis of control of the wave sources 3 (Step S104). The control device 10 generates a force having a desired direction, a desired intensity, and a desired shape at the target position on the basis of control of the wave sources 3 (Step S106).

As described above, according to the force field-generating device 1, by inputting ultrasonic waves having different frequencies advancing in a plurality of directions to the inside of an object and combining the ultrasonic waves at a target position, a force having a desired direction, a desired intensity, and a desired shape can be generated at the target position. According to the force field-generating device 1, a force that is stationary over time can be generated on the basis of a combined wave acquired by combining waves of the same frequency, and a force, which is stationary over time, having a spatial pattern that has a high degree of freedom and can be localized can be generated inside an object by further combining combined waves of a plurality of frequencies.

According to the force field-generating device 1, a force at an arbitrary position inside a human body can be generated, and it can be applied to a noninvasive treatment device. In addition, according to the force field-generating device 1, a force can be generated at an arbitrary position inside an object other than a human body, and it can be applied to a noninvasive repair device and a test device.

The control unit 11 described above is realized by a processor such as a central processing unit (CPU) or a graphics-processing unit (GPU) executing a program (software). Some or all of such functional units may be realized by hardware such as a large-scale integration (LSI), an application-specific integrated circuit (ASIC), or a field-programmable gate array (FPGA) or may be realized by software and hardware in cooperation. The program may be stored in a storage device such as a hard disk drive (HDD) or a flash memory included in the storage unit 12 or may be stored in a storage medium that can be loaded and unloaded such as a DVD or a CD-ROM and installed in a storage device by loading the storage medium in a drive device. In addition, the program is not essentially necessary, and, by configuring a sequential circuit in the control device 10, a predetermined operation may be performed.

Although one embodiment of the present invention has been described above, the present invention is not limited to the embodiment described above, and an appropriate change can be made therein in a range not departing from the concept thereof. For example, in the force field-generating device 1, the plurality of wave sources 3 may be an acoustic lens that causes ultrasonic waves output from sound sources to converge and forms a focus at a target position. In other words, the plurality of wave sources 3 may be microelements, which are modeled on the basis of computation, outputting ultrasonic waves in the acoustic lens. In such a case, an acoustic lens that outputs an ultrasonic wave of which a sound pressure and a phase are controlled on the basis of ultrasonic waves output from microelements serving as the plurality of wave sources 3 may be configured. In other words, the acoustic lens adjusts parameters of each ultrasonic wave output from each of microelements serving as the plurality of wave sources 3 on the basis of computation, and a shape thereof may be designed such that a desired force is generated at a target position by causing each ultrasonic wave to converge at the target position and forming a continuous sound source by taking a limit of each microelement. The acoustic lens designed in this way may be configured to individually adjust parameters of a direction, a frequency, an amplitude, and a phase of each ultrasonic wave in each microelement serving as the plurality of wave sources at the time of outputting ultrasonic waves, generate a plurality of ultrasonic waves having different frequencies from the microelements, combine a plurality of ultrasonic waves at a target position inside a target object, and generate a desired force. In the process of the control device 10 described above, by controlling the output unit 2, computation for generating a combined wave acquired by combining a plurality of ultrasonic waves approximated as planar waves at the target position through an acoustic lens may be included.

The present invention includes the following forms.

[1] A force field-generating device, including: an output unit including a plurality of wave sources that are disposed at different positions and generate ultrasonic waves; and a control device configured to individually control the plurality of wave sources, individually adjust parameters of a direction, a frequency, an amplitude, and a phase of each of the ultrasonic waves, generate the plurality of ultrasonic waves having different frequencies from the plurality of wave sources, combine the plurality of ultrasonic waves at a target position inside a target object, and generate a force having a desired direction, a desired intensity, and a desired shape.

[2] The force field-generating device described in [1], in which the control device generates a combined wave acquired by combining the plurality of ultrasonic waves approximated as a planar wave at the target position and generates the force on the basis of a localized vibration of the combined wave by controlling the output unit.

[3] The force field-generating device described in [1] or [2], in which the control device generates the force in an expanding direction from the target position by controlling the output unit.

[4] The force field-generating device described in any one of [I] to [3], in which the wave source includes a plurality of ultrasonic vibrators arranged in a matrix pattern, and the control device outputs an ultrasonic beam advancing in an arbitrary direction from the wave source by individually controlling frequencies, amplitudes, and phases of the ultrasonic waves output from the ultrasonic vibrators, outputs a plurality of ultrasonic beams advancing in different directions from the plurality of wave sources, and combines the plurality of ultrasonic beams at the target position.

[5] A force field-generating method, including: individually adjusting parameters of directions, frequencies, amplitudes, and phases of ultrasonic waves output from a plurality of wave sources of an output unit including the plurality of wave sources disposed at different positions; generating a plurality of the ultrasonic waves having different frequencies from the plurality of wave sources; combining the plurality of the ultrasonic waves at a target position inside a target object, and generating a force having a desired direction, a desired intensity, and a desired shape at the target position.

[6] A non-transitory storage medium storing a program causing a computer to perform a process including: individually adjusting parameters of directions, frequencies, amplitudes, and phases of ultrasonic waves output from a plurality of wave sources of an output unit including the plurality of wave sources disposed at different positions; generating a plurality of the ultrasonic waves having different frequencies from the plurality of wave sources; combining the plurality of the ultrasonic waves at a target position inside a target object, and generating a force having a desired direction, a desired intensity, and a desired shape at the target position.

### EXPLANATION OF REFERENCES

1 Force field-generating device
2 Output unit
3 Wave source
4 Ultrasonic vibrator
6 Wave source
10 Control device
11 Control unit
J, J1 to J4 Planar wave
M1 to M5 Combined wave
P Target object
R Target position

### PATENT DOCUMENTS

[Patent Document 1] Japanese Unexamined Patent Application, First Publication No. 2021-119486

### Non-Patent Documents

[Non-Patent Document 1] Keisuke Hasegawa, Hiroyuki Shinoda, and Takaaki Nara Journal of Applied Physics 127, 244904 (2020); “Volumetric acoustic holography and its application to self-positioning by single channel measurement” 23 Jun. 2020, https://aip.scitation.org/doi/10.1063/5.0007706

What is claimed is:

1. A force field-generating device, comprising:
an output unit including a plurality of wave sources that are disposed at different positions and generate ultrasonic waves; and
a control device configured to individually control the plurality of wave sources, individually adjust parameters of a direction, a frequency, an amplitude, and a phase of each of the ultrasonic waves, generate a plurality of ultrasonic waves having different frequencies from the plurality of wave sources, combine the plurality of ultrasonic waves at a target position inside a target object, and generate a force having a desired direction, a desired intensity, and a desired shape.

2. The force field-generating device according to claim 1, wherein the control device generates a combined wave acquired by combining the plurality of ultrasonic waves approximated as a planar wave at the target position and generates the force on the basis of a localized vibration of the combined wave by controlling the output unit.

3. The force field-generating device according to claim 1, wherein the control device generates the force in an expanding direction from the target position by controlling the output unit.

4. The force field-generating device according to claim 1,
wherein the wave source includes a plurality of ultrasonic vibrators arranged in a matrix pattern, and
wherein the control device outputs an ultrasonic beam advancing in an arbitrary direction from the wave source by individually controlling frequencies, amplitudes, and phases of the ultrasonic waves output from the ultrasonic vibrators, outputs a plurality of ultrasonic beams advancing in different directions from the plurality of wave sources, and combines the plurality of ultrasonic beams at the target position.

5. A force field-generating method, comprising:
individually adjusting parameters of directions, frequencies, amplitudes, and phases of ultrasonic waves output from a plurality of wave sources of an output unit including the plurality of wave sources disposed at different positions;
generating a plurality of the ultrasonic waves having different frequencies from the plurality of wave sources;
combining the plurality of the ultrasonic waves at a target position inside a target object, and
generating a force having a desired direction, a desired intensity, and a desired shape at the target position.

6. A non-transitory storage medium storing a program causing a computer to perform a process comprising:
individually adjusting parameters of directions, frequencies, amplitudes, and phases of ultrasonic waves output from a plurality of wave sources of an output unit including the plurality of wave sources disposed at different positions;
generating a plurality of the ultrasonic waves having different frequencies from the plurality of wave sources;
combining the plurality of the ultrasonic waves at a target position inside a target object, and
generating a force having a desired direction, a desired intensity, and a desired shape at the target position.
